(19) United States
(12) Patent Application Publication
(10) Pub. No.: US 2001/0009700 A1
(43) Pub. Date: Jul. 26, 2001

(54) PROCEDURE AND APPARATUS FOR TRANSFERRING OF ADDITION TO THE SURFACE OF A MOVABLE MATERIAL WEB

(76) Inventors: VEIKKO ILMASTI, HELSINKI (FI); TIMO NYBERG, ESPOO (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/254,945

(22) PCT Filed: Sep. 18, 1997
(86) PCT No.: PCT/FI97/00558

§ 371 Date: None

(30) Foreign Application Priority Data
Sep. 19, 1996 (FI) 963708

(51) Int. Cl. B05D 1/04; B05C 5/02

(52) U.S. Cl. 427/475; 427/482; 118/627; 118/629

(57) ABSTRACT

A method for transferring in an encapsulated space (1), with the aid of high voltage, additional material (5) onto the surface of a material web (2) moving through the space. The additional material which is added onto the surface of the material web (2) is brought into the housing (1) in a controlled manner in the form of dust or spray (5), for example. The dust or the spray particles are transferred onto the surface of the material web (2) in the encapsulated space (1) by using ion blasting.

The object of the invention is a method which is used to transfer, in an encapsulated space and by using high voltage, additional material onto the surface of a material web which moves through the encapsulated space.

One conventional manufacturing process of material is a continuous web formation process. These processes the include milling out of metals to form foil, and the manufacture of plastic and other coatings, films, paper, and cardboard. In addition to its geometric main form (flat and plate-like), many other properties are rendered to the material during the web formation process. One of the most common ways to provide the other properties referred to above is to manipulate the functional surface of the material. This manipulation can be effected either by adding a substance onto the surface of the base material, i.e., by coating, or by changing the properties of the material surface chemically, thermally, mechanically, electrically or in some other way.

In the known methods and devices, material has been transferred onto the surface of the web by spraying or by using a direct contact, such as painting with a brush. In both cases, the amount of transferred material has to be fairly large and, typically, solvents have to be used in the process to accomplish a sufficient mass flow rate. In spray painting, it is known to use an electric charge to advance the transfer of material. In this case, the nozzle of the paint spray constitutes one of the electrodes. This deviates fully from the method now presented in which the electrode is not provided in the nozzle. Furthermore, the voltage levels are different. Solvents are also used to advance the adhesion between the added substance and the web. A drawback then arises that the solvent has to be removed from the process; in the coating of paper, for instance, this implies expensive drying. To improve the printing qualities of the web materials, mainly plastics, a so-called corona charging system is used (less than 50 kV, typically less than 20 kV) in which the surface energy of a polymer film can be increased by using electric discharge. Therefore, the fairly low voltage that is used makes it necessary to use a small gap between the electrodes, making it difficult to control the process. Furthermore, the obtained power remains low because the current cannot be increased limitlessly. To make very thin coatings, so-called PVD technique (Physical Vapour Deposition) can be used but it requires a vacuum and, therefore, does not apply to coating a fast-moving web. Moreover, PVD often requires high temperatures.

The purpose of the invention is to eliminate the disadvantages presented above and to provide a new method and a device which can be used to apply additional material easily, quickly, and evenly onto the desired surface of a moving material web. The method according to the invention is characterised in that the additional material which is added onto the surface of the material web is brought into the housing in a controlled manner in the form of dust or spray, for example, and that the dust or the spray particles are transferred onto the surface of the material web in the encapsulated space by using ion blasting.

The device according to the invention is characterised in that the housing is provided with an opening through which the additional material is conveyed to the housing in the form of dust or spray, for example, and that high voltage is supplied to the high-voltage electrodes in the housing, providing ion blasting towards the material web moving through the housing, whereby the additional material in the form of dust or spray in the housing is transferred onto the surface of the material web with the aid of ion blasting.

Different embodiments of the invention are presented in the dependent claims of the array of claims.

The device is very well-adapted to transfer minor amounts of coating, such as a few grams or fractions of a gram per square meter in paper manufacture. Now very small amounts of chemicals can be added onto the surface of paper, for example, improving the operating characteristics of the paper. Up till now, it has been impossible or very difficult to spread small amounts of material evenly, or it has required a great amount of solvent, water or the like which has had to be removed from the paper afterwards.

In paper manufacture in particular, the use of water can be decreased, which is advantageous in many ways. For example, the need for drying is decreased and energy is saved; the amount of circulating water is decreased and the need for cleaning is reduced.

The invention is described in the following with the aid of an example and with reference to the appended drawing in which:

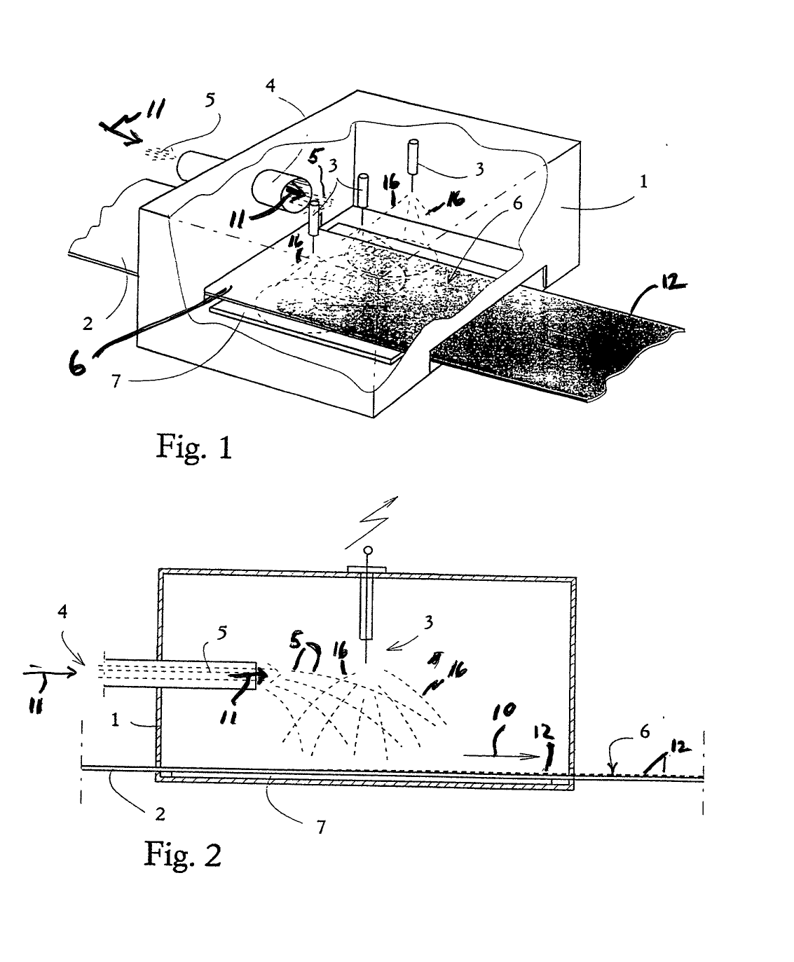

FIG. 1 is an axonometric, partly sectioned view of the device according to the invention, and

FIG. 2 shows the same device as FIG. 1 but as viewed directly from the side and cut open.

The device consists of housing 1 through which material web 2 moves, additional material being added onto the surface of the web with the aid of electrodes 3 in housing 1. Housing 1 is provided with opening 4 through which the additional materials is conveyed to the housing as indicated by arrow 5. The additional material is in the form of dust or spray, for example. High voltage is supplied to high-voltage electrodes 3 in housing 1, providing ion blasting towards material web 2 moving through the housing, whereby the additional material which is in the housing in the form of dust of spray is transferred onto surface 6 of material web 2 with the aid of ion blasting. Electrodes 3 are arranged above material web 2 so that the additional material settles and forms an even surface 6 on the upper surface of material web 2 with the aid of the ion blasting. Below material web 2 in the housing there is provided a plate-like electrode 7, the material web travelling on top of the electrode.

1. A method for transferring additional material (5) in an encapsulated space (1), with the aid of high voltage, onto the surface of a material web (2) moving through the space, characterised in that the additional material that is added onto the surface of the material web (2) is brought to the housing (1) in a controlled manner in the form of dust or spray (5), for example, and that the dust or the spray particles are transferred onto the surface of the material web (2) in the encapsulated space (1) by using ion blasting.

2. A method according to claim 1, characterised in that the ion blasting is provided by using electrodes (3) in the housing (1), a voltage of more than 50 kV being supplied to the electrodes.

3. A device for implementing the method according to the claim, comprising a housing (1) through which the material web (2) moves, additional material being added onto the surface of the web by using the electrodes (3) in the housing (1), high voltage being supplied to the electrodes, characterised in that the housing (1) is provided with an opening (4) through which the additional material is conveyed to the housing in the form of dust or spray (5), for example, and that high voltage is supplied to the high-voltage electrodes (3) in the housing (1), providing ion blasting towards the material web (2) moving through the housing (1), whereby the additional material in the form of dust or spray in the housing is transferred onto the surface (6) of the material web (2) with the aid of the ion blasting.

4. A device according to claim 3, characterised in that the electrodes (3) are arranged above the material web (2) so that the additional material settles and forms an even surface (6) on the upper surface of the material web (2) with the aid of the ion blasting.

5. A device according to claim 3 or 4, characterised in that a plate-like electrode (7) is provided below the material web (2) in the housing (1), the material web travelling on top of the electrode.
